(19) United States
(12) Patent Application Publication
(10) Pub. No.: US 2007/0008433 A1
(43) Pub. Date: Jan. 11, 2007

(54) Dual-mode acoustic tuning system and method

(76) Inventor: Rolf Goehler, Schaumburg, IL (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/171,206

(22) Filed: Jul. 1, 2005

(51) Int. Cl. H04N 5/44

(52) U.S. Cl. 348/725

(57) ABSTRACT

Automatic ringing/howling sound suppression from feedback or over amplifications in live performances is described An off-line approach to determine the major ring modes in the “room” is used, wherein narrow-band digital filters are used to attenuate the offending signals. Using high Q, highly stable digital filters, continuous control over these major ring nodes can be obtained. After an initial hunt is performed for the ring nodes through the use of ring node excitation signals, the first ring nodes or major ring nodes are attenuated to a increased level to improve the sound system's dynamic range. The excitation signal's level is controlled while it is injected to excite and detect the ring nodes of the room in a sequential manner. Filter parameters are created based on the location of the ring node(s) in the frequency spectrum and the required attenuation to eliminate it, resulting in an improved performance experience and yet controlling the detrimental aspects due to the acoustics.

### FIELD OF THE INVENTION

The present invention relates generally to sound control. More particularly, the present invention relates to automatic ring node detection and reduction for use in amplified performances. BACKGROUND OF THE INVENTION

Electronic amplification of sound is commonly employed in auditoriums, gymnasiums, meeting rooms, court rooms, music halls, etc. With the exception of certain music halls, the overall acoustic design of these facilities is not well tailored for optimal sound reproduction. Due to physical or structural constraints in these buildings, resonant nodes such as feedback or ring nodes can occur in the sound amplification process. When unchecked, the feedback results in a howling which is highly discomforting and disruptive.

Many conventional feedback suppression schemes attack the ring node issue after detection or presence is established (during the live performance) and in many cases these approaches effect the listening experience during the removal of the ring nodes. Similarly, automatic gain riding mixers (Automatic Mixer Amplifiers) control or attempt to control the overall amplification by using an attenuation algorithm based on the log (logarithmic value) of the number of open microphones (open sources) to regulate the overall system gain and thus attempt to avoid ring nodes (feedback frequencies)—is susceptible to changes in the input volume from the open sources i.e. dynamic range of the input signal. It cannot provide the attenuation necessary to remove the major ring nodes while still maintaining an overall good level of sound reinforcement, but rather attempts to maintain an overall frequency independent, maximum level of sound reinforcement in the system. This approach is generally relegated to meeting halls where the dynamic range of the input sources is more controllable i.e. a table of microphones (open sources) with participants mostly stationary.

Attempts to reduce or control excessive feedback are usually accomplished by “testing” the sound amplification system and adjusting gains therein. Such approaches are typically limited, on being dependent on a sound engineer's real-time assessment of the amplified sounds. Herethereto, there have been no automatic ring node elimination systems that easily and cost effectively reduce, control or/and eliminate ringing without disturbing the live performance, while providing a sufficient level of sound amplification into the listening environment.

Therefore, there has been a long standing need in the industry for systems and methods that address at least the above difficulties encountered in live performances.

### SUMMARY OF THE INVENTION

The foregoing needs are met, to a great extent, by the present invention, wherein in one aspect an apparatus is provided that in some automatically remove or suppress ringing sounds from feedback or over amplification in live performances.

In accordance with one embodiment of the present invention, an automatic ring node suppression system for amplified sound systems is provided, comprising an input signal conditioner, a signal bus coupled to an output of the input signal conditioner, a system controller coupled to the signal bus, a ring detector, a dynamic output signal conditioner, and a ring detector output and conditioned signal output combiner, wherein the ring detector generates an a priori ring node generating signal through the amplified sound system which is detected by the ring node suppression system and dynamically suppressed by the dynamic output signal conditioner.

In accordance with another embodiment of the present invention, a method for automatic ring node suppression for an amplified sound system is provided, comprising the steps of generating a ring node generating signal through the amplified sound system, conditioning a received input signal, detecting the ring node in the input signal, dynamically suppressing the ring node signal, and outputting a ring node suppressed signal through the amplified sound system.

In accordance with yet another embodiment of the present invention, an automatic ring node suppression system for amplified sound systems is provided, comprising input signal conditioning means for amplitude and frequency conditioning of the signal, communication means for communicating signals from the input signal conditioning means, a controller means for controlling an operation of the ring node suppression system, a ring detector means for at least generating and detecting a ring node signal, and an output signal conditioning means for suppressing a detected ring node signal and frequency conditioning the output signal.

There has thus been outlined, ratherbroadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic block diagram illustrating an exemplary embodiment of the invention.

### DETAILED DESCRIPTION

The invention will now be described with reference to the drawing figures, in which like reference numerals refer to like parts throughout. An embodiment in accordance with the present invention provides systems and methods for suppressing or canceling offending ringing/howling sounds from feedback or over amplifications in live performances. The exemplary system is capable of using an off-line approach to determine the major ring nodes in the room and attenuates these nodes through the use of narrow-band digital filters. These filters are preferably but not necessarily, high Q, highly stable digital filters that will allow for continuous control over these major ring nodes in the room. The exemplary system will initially automatically hunt the ring nodes through the use of excitation signals that will excite the room's ring nodes (resonant frequencies). The first ring nodes or major ring nodes, are attenuated to a higher level and thus improve the sound system's dynamic range more than the subsequent nodes. The excitation signal's level is controlled while it is injected to excite and detect the ring nodes of the room in sequential manner. The filter parameters are created based on the location of the ring node in the frequency spectrum and the required attenuation to eliminate it. The high Q filters will minimize the overall impact on the frequency band for the listener. Hence, the exemplary system improves the performance experience and yet controls the detrimental aspects arising from the acoustic environment.

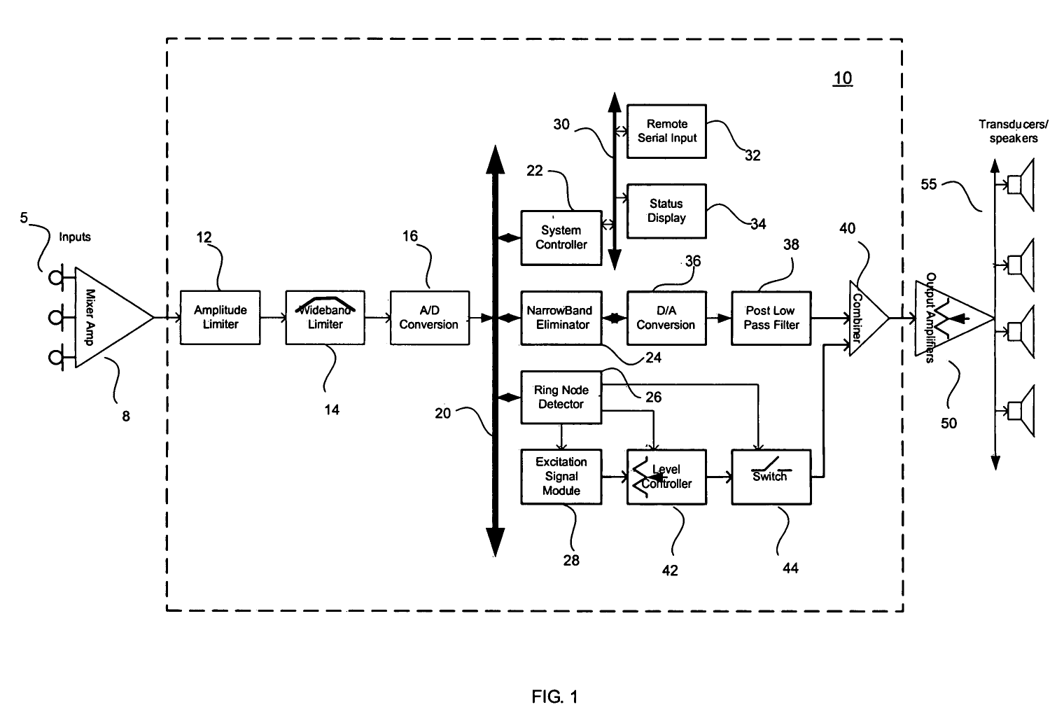

FIG. 1 is a block diagram illustrating in an exemplary dual mode acoustic tuning system 10 according to this invention. The tuning system 10 may be interposed between a conventional sound system having one or a series of microphones 5 connected to an input mixer amp 8 whose output is coupled to output amplifiers 50, which drive one or a series of transducers, hereinafter referred to generically as speakers 55. In addition to the microphones 5, the mixer amplifier 8 may also be coupled to various line sources (not shown) from instruments, soundtracks, or other sound generating devices. The exemplary tuning system 10 is coupled to the output of the mixer amp 8 and to the input of the output amplifiers 50. The exemplary tuning system 10 contains an input signal conditioning section comprising an input amplitude limiter 12 and wideband limiter 14. From the input signal conditioning section, an analog-to-digital (A/D) converter 16 (aka—ADC) is situated to convert the conditioned analog signal to a digital signal. A communication/signal bus 20 is coupled to the ADC 16 to distribute the output of the ADC 16 to a system controller 22, a narrowband eliminator 24, and a ring node detector 26. The system controller 22 is also coupled to a bus 30 that conveys information to a status display 34 and/or an external interface 32. The output of the narrowband eliminator 24 is coupled to a digital-to-analog converter 36 (DAC) which in turn is coupled to a low pass filter 38. The output of the low pass filter 38 is connected to a combiner 40, as further discussed below.

The ring node detector 26 is coupled to an excitation signal module 28, level controller 42 and switch 44. The output of the switch 44 is routed to the combiner 40, which, in combination with the output of the low pass filter 38, outputs its response to the output amplifier 50. 100171 In operation, an acoustic signal received by the microphone(s) 5 is converted into an electrical signal which is routed to the input mixer amp 8. The mixer amp 8 “mixes” and amplifies the various signals received from the microphone(s) 5. As alluded above, the mixer amp 8 may also mix in signals from separate line sources, such as, for example another mixer on alternative sound source (e.g., drum machine, synthesizer, keyboard, instruments, computerized signals, etc). The mixed signals are merged into a combined signal whose amplitude is limited by the amplitude limiter 12 at the “front-end” of the exemplary tuning system 10. The amplitude limiter 12 may be a simple gain control device that is automatic (e.g., AGC) or dynamic (e.g., operator or computer controlled, etc.). The amplitude limiter 12 reduces, as needed, the mixed signal's dynamic range to prevent saturation or distortion at the top end of the input signal and limits the input signal as required to the ADC 16. Upon appropriate amplitude limiting, the output signal from the amplitude limiter 12 is fed into a wideband limiter 14. The wideband limiter 14 is primarily a spectral band pass filter to eliminate spurious out-of-band signals or aliased signals arising from the sampling. In various exemplary embodiments, the band pass filter can be a low pass filter. However, other functions can be implemented according to design preference. From the wideband limiter 14, the signal is fed to the ADC 16. The ADC 16 converts the “filtered” analog input signal into a digital format. From the ADC 16, the digitally-converted signal is made available to the system/communication bus 20, which is coupled to the system controller 22.

The system controller 22 provides controlling and system management operation of the signal in the dual mode acoustic tuning system 10. The system controller 22 may be CPU, a microcontroller, or other logically operated device(s). The system controller 22 is also coupled to an internal bus 30 which conveys information to and from the system controller 22, to a remote interface 32 and a status display 34. The remote interface 32 enables communication to an external device (not shown) through an external communication bus 33. The external device may be a master controller or other adjunct device such as, for example, an equalizer, additional mixer amps 8, etc. The system controller's 22 data maybe displayed on the status display 34 for user feedback and intervention. The status display 34 may include knobs, switches, controls, touch-screen capabilities, etc., as is deemed necessary for proper control and monitoring of the dual mode acoustic tuning system 10. Additional interface, control, memory, processing, etc., devices may be coupled to the bus 30, as deemed necessary.

The system controller 22, in addition to providing controlling functions to the dual mode acoustic tuning system 10, may operate as a DSP and may sample the digitally-converted signal from the ADC 16, for signal integrity and processing. For example, the system controller 22, upon sampling the digital signal, may adjust the narrowband eliminator 24 for signal conditioning, as according to design preferences. As such, the system controller 22 may also control other devices coupled directly or indirectly to the system/communication bus 20.

Returning to operations on signals from the ADC 16 converter, appropriate narrowband elimination is performed by the narrow band eliminator 24 by utilizing a high Q digital bandstop (i.e., notch) filters that attenuate the identified ring nodes. The realization may be based on a Butterworth, Chebyshev or Cauer Laplace implementation, for example, with the digital coefficients determined by the system controller 22 for the ring node frequency and the depth of the notch required. Of course, other coefficient/filter realization schemes may be used, as well as cascading, paralleling, etc. the filters, according to design preference. The coefficient realization will be based on an algorithm, preferably, but not necessarily, a bilinear transformation, such as, for example, a Z-transform so that the analog filter transfer function can be transcribed to the digital domain.

In various exemplary embodiments, the notch depth for the bandstop filter(s) will be set approximately 3 dB above the amplitude measured in the ring node detector 26. The filter realization may use an Infinite Impulse Response (IIR) type to allow for a maximum number of bandstop filters from a given DSP and allow an easier transformation from the analog filter realization algorithms (Butterworth, Chebyshev or Cauer Laplace ‘S’ transforms to the digital ‘Z’ transforms), as well as a Finite Impulse Response (FIR) implementation, according to design preference. The filter coefficients will be loaded by the system controller 22 which maintains a database of the discovered ring nodes (frequencies) and the required notch depth settings. The system controller 22 also receives the ring node information (Frequency and Amplitude) from the ring node detector 26 to calculate the filter coefficients.

From the narrowband eliminator 24, the digital signal is converted back to its analog format via the ])AC 36. Upon conversion, the analog signal is post-filtered by a low pass filter 38 to remove any spurious signals or harmonics from the previous operations. The “conditioned” analog signal is then fed into the combiner 40. The combiner 40 combines the conditioned analog signal with the ring-node evaluated signal, as discussed below.

The ring-node evaluated signal is generated from operation of the ring node detector 26 which receives an output of the narrowband eliminator 24 from the system bus 20, and performs the ring detection. Ring detection can be accomplished by detecting any one or more of a ring characteristic such as, for example, high amplitude, resonance, frequency, peak(s), etc. Any commonly available ring node or “howling” detector, whether hardware implemented or software implemented maybe used.

In various exemplary embodiments, the ring node detector 26, when operating in a non-live performance mode, may use a pink noise excitation signal, controlling its level and introduction with level controller 42 and the switch 44, respectively, to the exemplary system. The ring node detector 26 receives the present digital signal after the narrowband eliminator's 24 operation and uses a sweeping digital high-Q bandpass filter or a tunable narrowband, high Q bandpass digital filter, and an amplitude measurement circuit (e.g., level controller 42) to detect/determine the associated peak characteristic of a ring node based on the nominal average amplitude reference measurements. Once the ring node detector 26 has isolated the ring node frequency and relative magnitude above the average level of the system, it transfers this information to the system controller 22, in order for the system controller 22 to calculate the bandstop filter coefficients to eliminate this ring node. The pink noise source, is understood in the art as a pseudo-random noise source that provides equal energy per octave. The ring node detector 26, in conjunction with the system controller 42 will increase the level of pink noise in 1 dB increments to hunt for the next ring mode. It should be noted that one may also use a sweep oscillator as the excitation source to find ring nodes at different energy levels introduced into the room.

In a live performance mode of operation, the ring node detector 26 may use either a sweeping digital high-Q bandpass and amplitude measurement, and track the persistence of the amplitude at certain frequencies over a time range or it performs a Fast Fourier Transform (FFT) algorithm on the narrowband eliminator 24 data and tracks the amplitude persistence of frequencies again over a time range of several seconds to establish new ring nodes or additional attenuation requirements on previous ring nodes due to changes in the performance's acoustic sources and locations. While various elements of the ring node detector 26 and its attendant circuits 28, 42 and 44 are shown as being independently operated, specialized systems or hardware, having a single all-performing configuration, maybe used, according to design preference.

An excitation signal module 28 is coupled to the ring node detector 26 which is coupled to the level controller 42 and switch 44. The ring node detector 26 and the attendant devices (e.g., 28, 42 and 44) provide a ring detection and/or triggering mode of operation. In the triggering mode of operation, the excitation module 28 generates a ring node excitation signal which is level controlled by the level controller 42. The level controller 42, as shown in FIG. 1 is controlled by the ring node detector 26. The output of the level controller 42, which is ring excitation signal is input to a switch 44, which is also controlled by the ring node detector 26. The output from the switch 44 is input into the combiner 40 which is combined with the processed miked input signal for conversion to an audible signal via the output amplifiers 50 and transducers/speakers 55.

In a ring mode of operation or triggering state, the exemplary dual mode acoustic tuning system 10 generates a ringing signal within the acoustic environment under test which is in turn received by the microphones 5 and input into the dual mode acoustic tuning system 10, for appropriate processing and acoustic environment characterization. In various exemplary embodiments, the excitation signal module 28 simply generates tones, combinations of tones or pseudo-random pink noise for audible translation to perform a spectral analysis of the acoustic environment. Individual tones or sounds may be generated or groups therein or sweeping signal may be used to comprehensively evaluate the sound and/or ring response characteristics of the acoustic environment. In the ring generation mode, frequencies or combinations of frequencies that are detected by the dual mode acoustic tuning system 10 as having ring or “howling” generation qualities can be evaluated by the system controller 22 for suppression or modification.

In the ring node detection scheme mode of operation, the exemplary dual mode acoustic tuning system 10 receives signals detected by the microphones 5 which are ultimately received on the system/communication bus 20. From the system/communication bus 20, the ring node detector 26, having detection qualities designated by the system controller 22 or pre-designated ring node detection qualities, evaluates the input signal for ring detection. When a ring is detected, the ring node detector can eliminate the offending ring signal notifying the system controller 22 to adjust the narrow band eliminator 24 to notch out the offending ring signal.

Accordingly, by utilizing the various components described herein, the ringing can be quickly and automatically eliminated or suppressed. It should be appreciated that in addition to the schemes described herein for ring detection and elimination, various other schemes that are available to one of ordinary skill in the art may be implemented without departing from the spirit and scope of this invention. For example, while FIG. 1 illustrates a dual mode acoustic tuning system 10 as having discrete ring node control devices such as, the excitation module 28, the level controller 42, and the switch 44, a single frequency and/or amplitude detection and notching circuit may be used, according to design preferences.

It should be appreciated that the ring generation scheme described above uses controlled excitation signals for acoustic environment characterization prior to the live performance. By characterizing the responses of the acoustic environment and any ring inducing sounds, the exemplary dual mode acoustic tuning system 10 can adjust the narrow band digital filter(s) in the narrow band eliminator 24 to attenuate and eliminate the ring nodes or feedback frequencies. The pre-live performance or off-line testing will facilitate the removal of major ring nodes in a room and hence prevent further disturbances during the live performance. By utilizing the off-line approach, the exemplary system provides for sufficient improved dynamic signal range before additional ring nodes or same ring nodes can reappear. Due to the pre-live performance elimination of major ring nodes, the system can rapidly adjust to changes in the acoustic environment such as open source location changes, large input level changes, etc. 100311 It should be appreciated that external processing capabilities that are complementary or adjunct may be used via the external communication bus 33 to provide remote monitoring, diagnostics and control for enhanced performance. Additionally, remote computation of acoustic or signal parameters to further optimize the narrow band filter and optionally perform off-site sensitivity analysis can be performed. In various exemplary embodiments, a Monte Carlo analysis may be used, as deemed necessary. Due to the incorporation of an external communication bus 33, remote incorporation of application software in control programs for the exemplary dual mode acoustic tuning system 10 can be facilitated. Additionally, manual overrides and/or fine tuning capabilities may be implemented via the status display 34 or through a manual override system (e.g., manual analog notch filters, feedback or equalizer units, automatic mixer amplifiers, etc.) in the event a manual override is necessitated.

The exemplary system is capable of using an off-line approach to determine the major ring modes in the room and attenuates these nodes through the use of fixed narrow-band digital filters. These filters are preferably but not necessarily, high Q's, highly stable digital filters that will allow for continuous control over these major ring nodes in the room. The exemplary system can automatically hunt the ring nodes through the use of excitation signals that will excite the room's ring modes (resonant frequencies). The first ring nodes, major ring nodes, are attenuated to a higher level and thus improve the sound systems dynamic range more than the subsequent nodes. The excitation signal's level is controlled while it is injected to excite and detect the ring modes of the room in sequential manor. The filter parameters are created based on the location of the ring node in the frequency spectrum and the required attenuation to eliminate it. The high Q filters will minimize the overall impact on the frequency band for the listener. Hence, improving the performance experience and yet controlling the detrimental aspects due to the acoustics.

The use of the dual mode approach to tuning of the acoustic room environment overcomes many of today's limitations in the real-time dynamic systems or/and the approximate approaches using simple gain (amplification) limiting techniques based on the open number of microphones (live sources) and the supporting limiter devices (limiter, compressors, gated channels). It also allows for the ability to optimize the sound system for each performance configuration in its acoustic environment i.e. for the microphone and input source locations including tapestry and scene backdrops.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents maybe resorted to, falling within the scope of the invention.

What is claimed is:

1. An automatic ring node suppression system for amplified sound systems, comprising:
an input signal conditioner;
a signal bus coupled to an output of the input signal conditioner;
a system controller coupled to the signal bus;
a ring detector;
a dynamic output signal conditioner; and
a ring detector output and conditioned signal output combiner,
wherein the ring detector generates an a priori ring node generating signal through the amplified sound system which is detected by the ring node suppression system and dynamically suppressed by the dynamic output signal conditioner.

2. The ring node suppression system according to claim 1, wherein the ring detector contains a separate ring node excitation signal module.

3. The ring node suppression system according to claim 1, wherein the ring detector contains a controllable level controller.

4. The ring node suppression system according to claim 1, wherein the ring detector contains a controllable switch.

5. The ring node suppression system according to claim 1, wherein the input signal conditioner contains an amplitude limiter.

6. The ring node suppression system according to claim 1, wherein the input signal conditioner contains a wideband limiter.

7. The ring node suppression system according to claim 1, wherein the input signal conditioner contains an analog-to-digital converter (ADC).

8. The ring node suppression system according to claim 1, wherein the signal bus is coupled to an output of the ADC.

9. The ring node suppression system according to claim 1, wherein the dynamic output signal conditioner contains a narrowband eliminator.

10. The ring node suppression system according to claim 1, wherein the dynamic output signal conditioner contains a digital-to-analog converter (DAC).

11. The ring node suppression system according to claim 1, wherein the dynamic output signal conditioner contains a low pass filter (LPF).

12. The ring node suppression system according to claim 1, wherein the system controller is coupled to a display.

13. The ring node suppression system according to claim 1, wherein the system controller is coupled to an output device interface.

14. A method for automatic ring node suppression for an amplified sound system, comprising the steps of:
generating a ring node generating signal through the amplified sound system;
conditioning a received input signal;
detecting the ring node in the input signal;
dynamically suppressing the ring node signal; and
outputting a ring node suppressed signal through the amplified sound system.

15. The method for automatic ring node suppression according to claim 14, wherein the step of suppressing is performed by a narrowband eliminator.

16. The method for automatic ring node suppression according to claim 14, wherein the step of conditioning includes:
amplitude limiting the received input signal;
wideband limiting the received input signal; and
converting the received input signal into a digital format.

17. The method for automatic ring node suppression according to claim 14, wherein the step of dynamically suppressing includes:
controlling a level of the generated ring node signal; and
adjusting the dynamically suppressing step by a system controller.

18. The method for automatic ring node suppression according to claim 14, wherein the step adjusting the dynamically suppressing step includes:
displaying a status of the detected ring node.

19. An automatic ring node suppression system for amplified sound systems, comprising:
input signal conditioning means for amplitude and frequency conditioning of the signal;
communication means for communicating signals from the input signal conditioning means;
a controller means for controlling an operation of the ring node suppression system;
a ring detector means for at least generating and detecting a ring node signal; and
an output signal conditioning means for suppressing a detected ring node signal and frequency conditioning the output signal.

20. The automatic ring node suppression system according to claim 19, further comprising:
a signal converter means for converting at least an analog signal to a digital signal or a digital signal to an analog signal.
